(19) United States
(12) Patent Application Publication
(10) Pub. No.: US 2014/0174179 A1
(43) Pub. Date: Jun. 26, 2014

(54) INERTIAL SENSOR AND METHOD OF MANUFACTURING THE SAME

(71) Applicant: SAMSUNG ELECTRO-MECHANICS CO., LTD., Suwon-si (KR)

(72) Inventors: Hyun Kee Lee, Suwon-si (KR); Sang Kee Yoon, Suwon-si (KR)

(73) Assignee: SAMSUNG ELECTRO-MECHANICS CO., LTD., Suwon-si (KR)

(21) Appl. No.: 14/140,245

(22) Filed: Dec. 24, 2013

(30) Foreign Application Priority Data
Dec. 24, 2012 (KR) 10-2012-0152395/

(51) Int. Cl. G01C 19/56; G01C 25/00

(52) U.S. Cl. CPC G01C 19/56; G01C 25/00
USPC 73/504.04; 29/25.35

(57) ABSTRACT

Disclosed herein is an inertial sensor, including: a structural part for an accelerator sensor disposed on one surface, centered on a common post; and a structural part for an angular velocity sensor disposed on the other surface, centered on the common post, wherein a piezoresistor of the structural part for the accelerator sensor and a piezoelectric material of the structural part for the angular velocity sensor are formed on different surfaces.

### CROSS REFERENCE TO RELATED APPLICATION

This application claims the benefit of Korean Patent Application No. 10-2012-0152395, filed on Dec. 24, 2012, entitled “Inertial Sensor And Method Of Manufacturing The Same” which is hereby incorporated by reference in its entirety into this application.

### BACKGROUND OF THE INVENTION

1. Technical Field

The present invention relates to an inertial sensor and a method of manufacturing the same.

2. Description of the Related Art

An inertial sensor has been used in various fields, for example, the military, such as an artificial satellite, a missile, an unmanned aircraft, and the like, an air bag, vehicles such as an electronic stability control (ESC), a black box for a vehicle, and the like, motion sensing of a hand shaking prevention camcorder, a mobile phone, and a game machine, navigation, and the like.

The inertial sensor is classified into an acceleration sensor that may measure a linear motion and an angular velocity sensor that may measure a rotating motion.

Acceleration may be calculated by Newton's law of motion “F=ma”, where “m” represents a mass of a moving body and “a” is acceleration to be measured. Further, angular velocity may be calculated by Coriolis force “F=2mΩ×v”, where “m” represents the mass of the moving body, “Ω” represents the angular velocity to be measured, and “v” represents the motion velocity of the mass. In addition, a direction of the Coriolis force is determined by an axis of velocity v and a rotating axis of angular velocity Ω.

The inertial sensor may be divided into a ceramic sensor and a microelectromechanical systems (MEMS) sensor according to a manufacturing process. Among others, the MEMS sensor is classified into a capacitive type, a piezoresistive type, a piezoelectric type, or the like, according to a sensing principle.

In particular, as the MEMS sensor can be easily manufactured in a small size and a light weight by using a MEMS technology as described in Patent Document

For example, the inertial sensor is being continuously developed from a uniaxial sensor capable of detecting only an inertial force for a single axis using a single sensor to a multi-axis sensor capable of detecting an inertial force for a multi-axis of two axes or more using a single sensor.

Further, the inertial sensor according to the related art needs to be small and multi-functional so as to be applied to various fields.

However, the inertial sensor according to the related art separately includes a structural part for the accelerator sensor and a structural part for an angular velocity sensor, so that the small and multi-functional inertial sensor cannot be implemented.

### Related Art Document

### Patent Document

(Patent Document 1) Korean Patent Laid-Open Publication No. 2011-0072229 (Laid-Open Publication: Jun. 29, 2011)

### SUMMARY OF THE INVENTION

The present invention has been made in an effort to provide an inertial sensor including a structural part for an accelerator sensor and a structural part for an angular velocity sensor integrally formed.

Further, the present invention has been made in an effort to provide a method of manufacturing an inertial sensor including a structural part for an accelerator sensor and a structural part for an angular velocity sensor integrally formed so as to improve process compatibility.

According to a preferred embodiment of the present invention, there is provided an inertial sensor, including: a structural part for an accelerator sensor disposed on one surface, centered on a common post; and a structural part for an angular velocity sensor disposed on the other surface, centered on the common post, wherein a piezoresistor of the structural part for the accelerator sensor and a piezoelectric material of the structural part for the angular velocity sensor are formed on different surfaces.

The piezoresistor of the structural part for the accelerator sensor and the piezoelectric material of the structural part for the angular velocity sensor may be formed in an origin symmetric form, centered on the common post.

The inertial sensor may further include: a cap covering one surface; and an ASIC chip electrically connected with the other surface, corresponding to the cap.

The structural part for the angular velocity sensor may include: a first electrode and a second electrode connected with the piezoelectric material, and the first electrode and the second electrode are electrically connected with the ASIC chip by flip bonding.

The structural part for the angular velocity sensor may include: an electrode connected with the piezoresistor; and a wire penetrating through one portion of the cap to electrically connect between the electrode and the ASIC chip.

The structural part for the angular velocity sensor may further include: the piezoresistor disposed at an outer side of a second membrane extendedly disposed on one surface of the common post; an accelerator mass body disposed under the second membrane, corresponding to the piezoresistor; and a post surrounding the accelerator mass body.

The structural part for the angular velocity sensor may further include: the piezoresistor disposed at an outer side of a first membrane extendedly disposed on the other surface of the common post; an angular velocity mass body disposed under the first membrane, corresponding to the piezoresistor; and a post surrounding the angular velocity mass body.

According to another preferred embodiment of the present invention, there is provided a method of manufacturing an inertial sensor, including: (A) preparing a first substrate including a first membrane and a second substrate including a second membrane; (B) bonding the first substrate and the second substrate to each other so as to expose the first membrane and the second membrane; (C) forming an upper structure of a structural part for an accelerator sensor including a piezoresistor disposed on one surface of an outer side of the second membrane and an electrode connected with the piezoresistor; (D) forming an upper structure of a structural part for an angular velocity sensor including a piezoresistor disposed on one surface of an outer side of the first membrane and an electrode connected with the piezoresistor; (E) forming an angular velocity mass body contacting the first membrane and a post surrounding the angular velocity mass body, corresponding to the piezoelectric material; and (F) forming an accelerator mass body contacting the second membrane, a post surrounding the accelerator mass body, and a common post disposed at a center between the angular velocity mass body and the accelerator mass body, corresponding to the piezoresistor.

The method of manufacturing an inertial sensor may further include: (H) forming a cap on one surface of the inertial sensor; and (I) disposing an ASIC chip on the other surface of the inertial sensor, corresponding to the cap.

The piezoresistor of the structural part for the accelerator sensor and the piezoelectric material of the structural part for the angular velocity sensor may be formed in an origin symmetric form, centered on the common post.

The first substrate and the second substrate may be a silicon substrate or a silicon on insulator (SOI) substrate.

The step (E) may include: (E-1) forming a first passivation layer covering an upper structure of the structural part for the accelerator sensor; (E-2) forming the angular velocity mass body and a post surrounding the angular velocity mass body by an etching process using the first passivation layer; and (E-3) removing the first passivation layer.

The step (F) may include: (F-1) forming a second passivation layer covering an upper structure of the structural part for the angular velocity sensor; (F-2) forming the accelerator mass body, a post surrounding the accelerator mass body, and a common post disposed at a center between the angular velocity mass body and the accelerator mass body by the etching process using the second passivation layer; and (F-3) removing the second passivation layer.

A wire may penetrate through one portion of the cap to electrically connect between the electrode connected with the piezoresistor and the ASIC chip.

The electrode connected with the piezoelectric material may be electrically connected with the ASIC chip by flip bonding.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplified diagram of a section of an inertial sensor according to a preferred embodiment of the present invention mounted in an ASIC; and

FIGS. 2A to 2L are process cross-sectional views for describing a method of manufacturing an inertial sensor according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

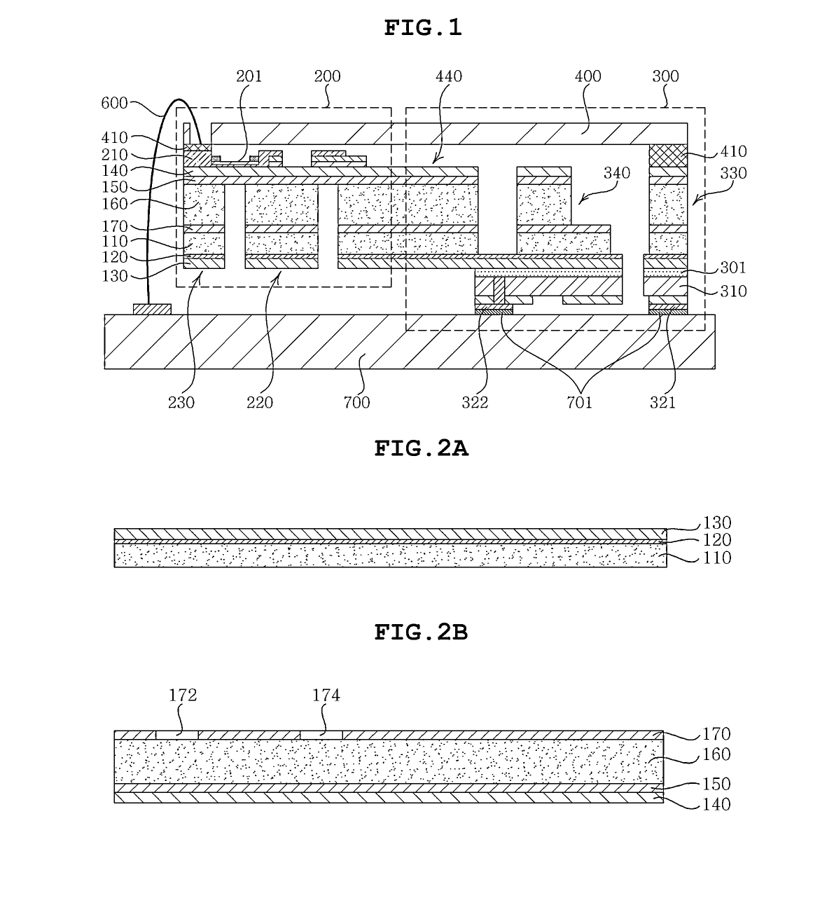

FIG. 1 is an exemplified diagram of a section of an inertial sensor according to a preferred embodiment of the present invention mounted in an ASIC. Herein, FIG. 1 illustrates a form in which the inertial sensor according to the preferred embodiment of the present invention is mounted in an application specific integrated circuit (ASIC) chip 700, but the preferred embodiment of the present invention is not limited thereto, and therefore the inertial sensor may be mounted in other apparatuses other than the ASIC 700.

The inertial sensor according to the preferred embodiment of the present invention includes a structural part 200 for an accelerator sensor and a structural part 300 for an angular velocity sensor integrally formed and the structural part 200 for an accelerator sensor and the structural part 300 for an angular velocity sensor are connected with each other via a common post 440. In the inertial sensor, a cap 400 is bonded to an upper part of the inertial sensor, corresponding to an ASIC 500, the structural part 200 for an accelerator sensor and an ASIC chip 700 are electrically connected with each other via a wire 600, and the structural part 300 for an angular velocity sensor and the ASIC chip 700 are electrically connected with each other via a conductive adhesive 701.

The inertial sensor according to the preferred embodiment of the present invention has a structure in which the structural part 200 for an accelerator sensor and the structural part 300 for an angular velocity sensor are integrated by using a silicon substrate or a silicon on insulator (SOI) substrate and includes a piezoresistor 201 of the structural part 200 for an accelerator sensor formed on one surface of the integrated structure and a piezoelectric material 310 of the structural part 300 for an angular velocity sensor formed on the other surface of the integrated structure, centered on the common post 440. In this case, the piezoresistor 201 portion and the piezoelectric 310 portion may be provided in an origin symmetric structure, setting the common post 440 as an origin point.

The structural part 200 for an accelerator sensor includes the piezoresistor 201 disposed on a second membrane 140, an accelerator electrode 210 electrically connected with the piezoresistor 201, an accelerator mass boy 220 disposed under the second membrane 140, a post 230 surrounding the accelerator mass body 220, and the common post 440.

The piezoresistor 201 has resistance changed according to elastic deformation of the second membrane 140 and the change degree of resistance may be detected by an electrode 210. Information on the detected change degree of resistance of the piezoresistor 210 may be transferred to the ASIC chip 700 via the wire 600 connected with the electrode 210.

The accelerator mass body 220 is displaced by inertial force, Coriolis force, external force, driving force, and the like. In this case, the displacement is transferred to the piezoresistor 201 and is shown as the change in resistance of the piezoresistor 201.

The post 230 and the common post 440 support the second membrane 140 to secure a space in which the accelerator mass body 220 may be displaced and serves as a reference when the accelerator mass body 220 is displaced.

The structural part 330 for an angular velocity sensor includes the piezoelectric material 310 disposed under the first membrane 130, having an insulating layer 301 interposed therebetween, a first electrode 321 and a second electrode 322 disposed under the piezoelectric material 310, having the insulating layer interposed therebetween, an angular velocity mass body 340 disposed above the first insulating layer 120, corresponding to the piezoelectric material 310, a post 330 surrounding an angular velocity mass body 340 above the first insulating layer 120, and the common post 440.

The piezoelectric material 310 may sense the vibration change in the angular velocity mass 340 in one axis direction by using a piezoelectric effect that generates positive charges and negative charges in proportion with external force when being applied with external force. Herein, the piezoelectric material 310 may be formed of, for example, lead zirconate titanate (PZT), barium titanate (BaTiO3), lead titanate (PbTiO3), lithium niobate (LiNbO3), quartz (SiO2), and the like.

Therefore, the first electrode 321 and the second electrode 322 may sense the vibration change in the angular velocity mass body 340 by using the piezoelectric material 310 and the ASIC chip 700 may detect pressure or angular velocity according to the information on the vibration change in the angular velocity mass body 340 received from the first electrode 321 and the second electrode 322.

The inertial sensor according to the preferred embodiment of the present invention is a structure in which the structural part 200 for an accelerator sensor and the structural part 300 for an angular velocity sensor are integrally connected with each other via the common post 440, in particular, a structure in which the piezoreistor 201 of the structural part 200 for an accelerator sensor is disposed on one surface of the structure including the common post 440 and the piezoelectric material 310 of the structural part 300 for an angular velocity sensor is disposed on the other surface of the structure including the common post 440, setting the common post 440 as an origin point.

Therefore, the inertial sensor according to the preferred embodiment of the present invention may be one structure to easily perform the function and operation of the accelerator sensor and the angular velocity sensor, such that the small and multi-functional inertial sensor can be implemented.

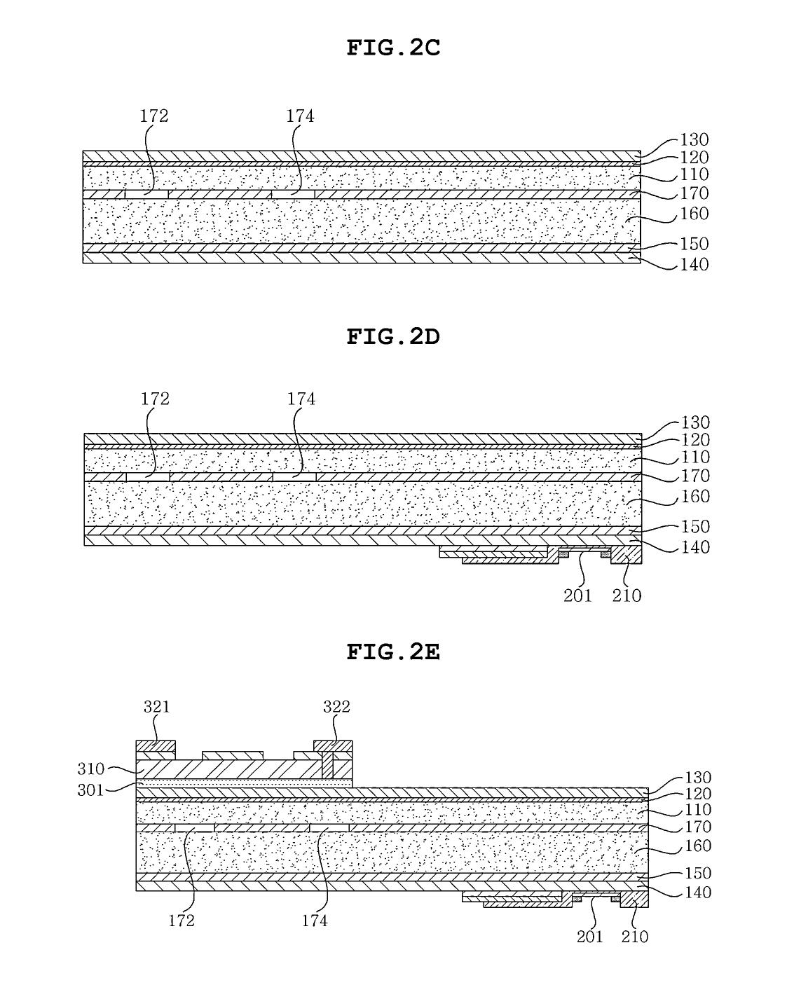

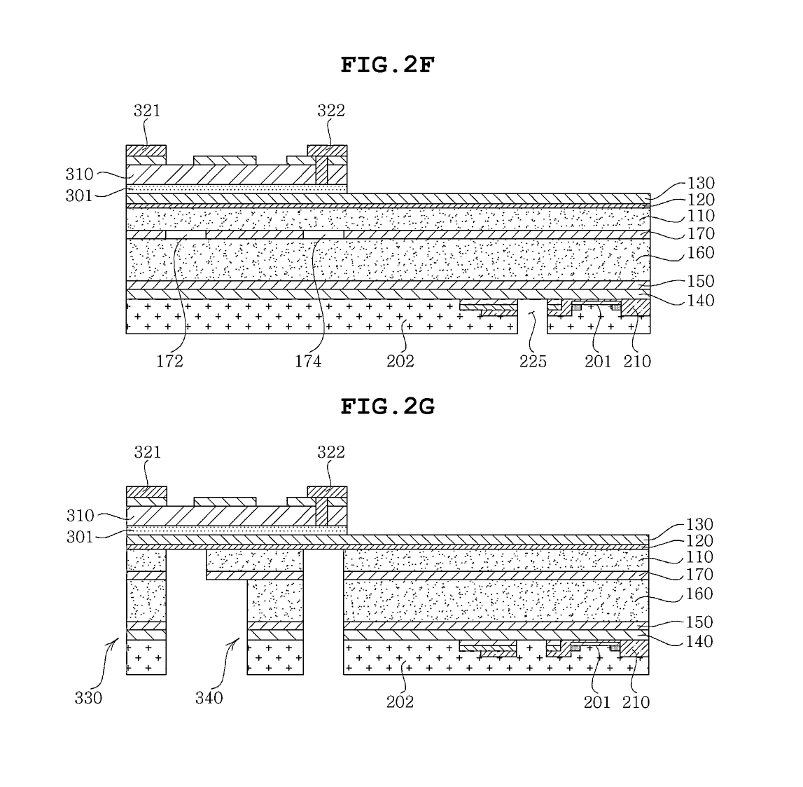

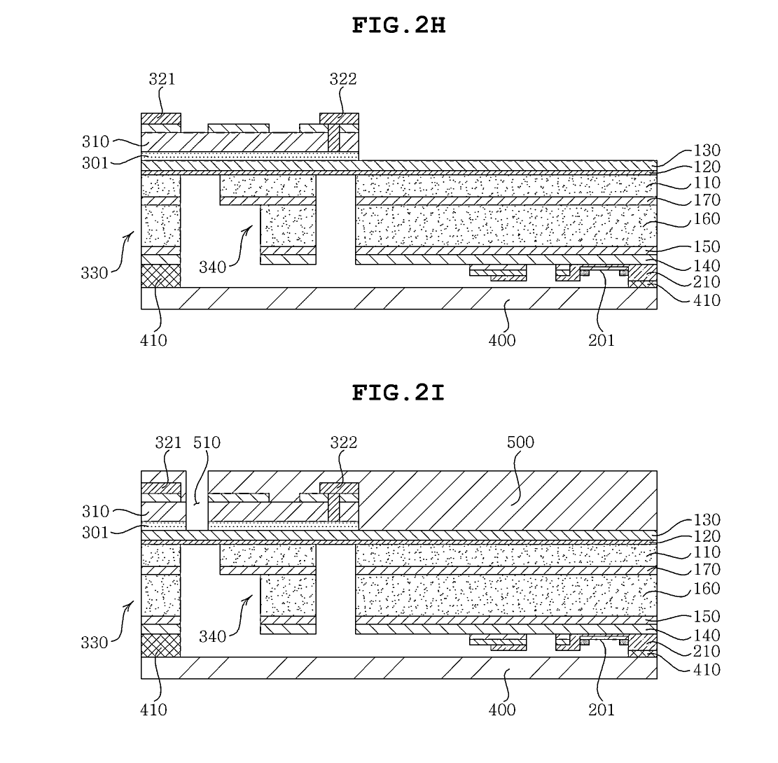

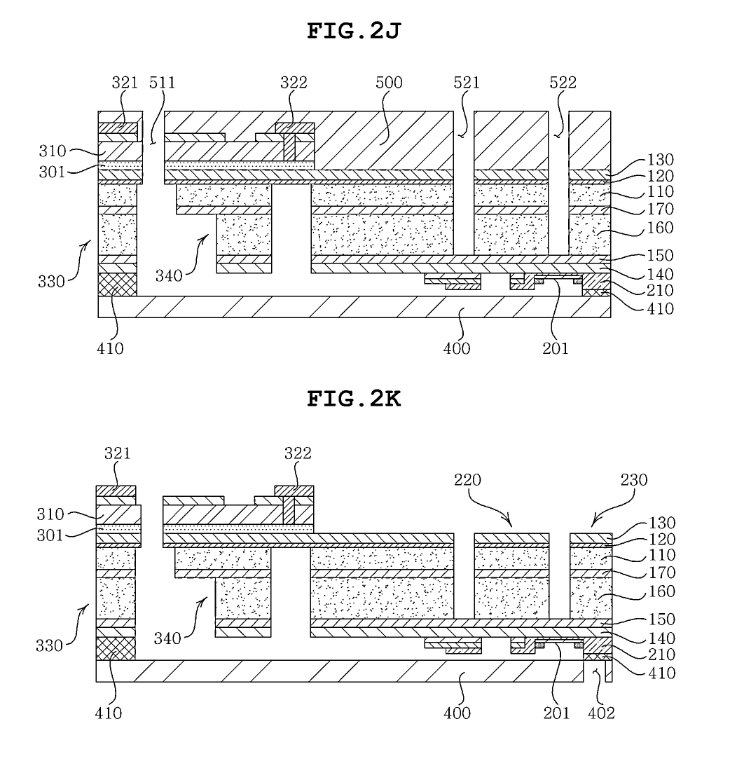

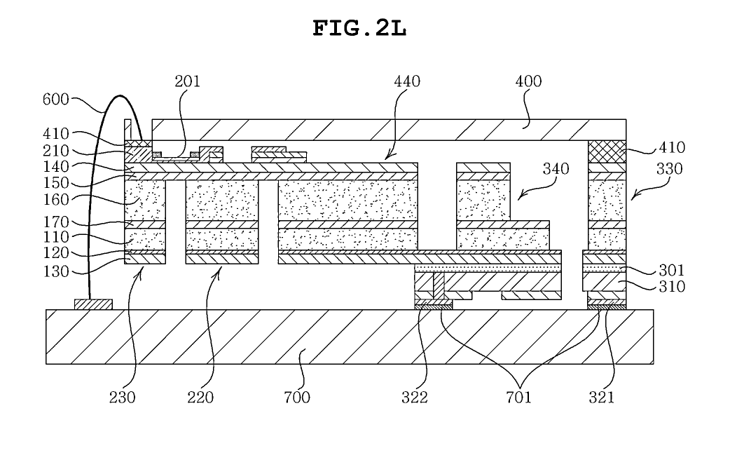

Hereinafter, a method of manufacturing an inertial sensor according to the preferred embodiment of the present invention will be described with reference to FIGS. 2A to 2L. FIGS. 2A to 2L are process cross-sectional views for describing a method of manufacturing an inertial sensor according to another preferred embodiment of the present invention.

In the method of manufacturing an inertial sensor according to the preferred embodiment of the present invention, a first SOI substrate illustrated in FIG. 2A and a second SOI substrate illustrated in FIG. 2B are first prepared.

In detail, the first SOI substrate illustrated in FIG. 2A, which is a substrate easily subjected to a microelectromechanical systems (MEMS) process, is prepared in a structure in which the first insulating layer 120 formed of oxide silicon and a first membrane 130 are sequentially stacked, for example, upwardly from the first silicon layer 110.

Further, the second SOI substrate illustrated in FIG. 2B may be sequentially stacked with a third insulating layer 150 formed of oxide silicon and the second membrane 140 downwardly from a center of the second silicon layer 160 and the upper surface of the second silicon layer 160 may be provided with a second insulating layer 170 formed of oxide silicon. In this case, the second insulating layer 170 may be provided with a first space 172 and a second space 174 that are a position reference for forming the post 330, the angular velocity mass body 340, and the common post 440 to be described below.

Herein, using the first SOI substrate and the second SOI substrate are by way of example only and the SOI substrate is not necessarily used, and therefore all the known substrates to in the art such as a silicon substrate, and the like, may be used.

Next, as illustrated in FIG. 2C, the first SOI substrate and the second SOI substrate are bonded to each other by, for example, a silicon direct bonding (SDB) method.

In detail, the first silicon layer 110 is bonded to the second insulating layer 170, so that the first membrane 130 of the first SOI substrate and the second membrane 140 of the second SOI substrate are exposed to the outside.

After the first membrane 130 and the second membrane 140 are exposed, as illustrated in

FIG. 2D, the upper structure of the structural part 200 for the accelerator sensor including the piezoresistor 201 and the electrode 210 is formed on one surface of the second membrane 140.

That is, as illustrated in FIG. 2D, the upper structure of the structural part 200 for an accelerator sensor may be formed by forming the insulating layer (not illustrated) on one surface of the second membrane 140 corresponding to the structural part 200 for an accelerator sensor, forming the piezoresistor 201 by implantation of impurities, such as B, and the like and high annealing processing, and forming the electrode 210 connected with the piezoresistor 201.

After the upper structure of the structural part 200 for an accelerator sensor is formed, as illustrated in FIG. 2E, the upper structure of the structural part 300 for an angular velocity sensor including the piezoelectric material 310 and the first electrode 321 and the second electrode 322 connected with the piezoelectric material 310 that are disposed on one surface of the first membrane 130 corresponding to the structural part 300 for an angular velocity sensor via the insulating layer 301 is formed.

In detail, the piezoelectric material 310 may be formed of, for example, lead zirconate titanate (PZT), barium titanate (BaTiO₃), lead titanate (PbTiO₃), lithium niobate (LiNbO₃), quartz (SiO₂), and the like.

In this case, the reason why the upper structure of the structural part 200 for an accelerator sensor including the piezoresistor 201 is formed on one surface of the second membrane 140 and the upper structure of the structural part 300 for an angular velocity sensor including the piezoelectric material 310 is formed on one surface of the first membrane 130 is to prevent the annealing processing from having a bad effect on the piezoelectric material 310 during the process of forming the piezoresistor 201 since the piezoelectric material 310 is vulnerable to high temperature.

Therefore, the upper structure of the structural part 200 for an accelerator sensor including the piezoresistor 201 is first formed on one surface of the second membrane 140 and the piezoresistor 201 and the piezoelectric material 310 may be each formed on different surfaces to prevent the bad effect of the piezoelectric material 310 due to high temperature and improve the process compatibility.

Next, as illustrated in FIG. 2F, a first passivation layer 202 is formed on one surface of the second membrane 140 including the piezoresistor 201.

The first passivation layer 202 may be formed of silicon oxide or silicon nitride so as to passivate the upper structure of the structural part 200 for an accelerator sensor including the piezoresistor 201 during the subsequent etching process.

In this case, the first passivation layer 202 may be divided and formed into a driving electrode and a sensing electrode to form patterns such as an opening portion 225 by etching.

Next, as illustrated in 2G, the opening portion 225 of the first passivation layer 202 is buried and the post 330 and the angular velocity mass body 340 are formed by performing the etching process using the first space 172 and the second space 174.

In this case, the etching process for forming the post 330 and the angular velocity mass body 340 is performed by setting the first space 172 and the second space 174 as the position reference.

After the post 330 and the angular velocity mass 340 are formed, as illustrated in FIG. 2H, the first passivation layer 202 is removed and the cap 400 is bonded by an adhesive 410.

In detail, the cap 400 may be bonded by the adhesive 410 that is applied to the post 330 and the electrode 210 at corner parts. The cap 400 is provided to act to passivate the upper structure of the structural part 200 for an accelerator sensor including the angular velocity mass body 340 and the piezoresistor 201. In particular, the cap 400 is spaced apart from the angular velocity mass 340 so as to secure a space in which the angular velocity mass body 340 may be displaced.

After the cap 400 is provided, as illustrated in FIG. 2I, the second passivation layer 500 is formed on one surface of the first membrane 130 including the upper structure of the structural part 300 for an angular velocity sensor including the piezoelectric material 310. Herein, the second passivation layer 500 may be formed of, for example, oxide silicon or silicon nitride, likewise the first passivation layer 202.

In addition, the second passivation layer 500 may also be provided with a primarily etched opening portion 510 as far as the insulating layer 301 so as to form a through hole 511.

After the second passivation layer 500 is formed, as illustrated in FIG. 2J, the through hole 511 penetrating from the opening portion 510 to the first insulating layer 120 is formed and at the same time, the first opening portion 521 and the second opening portion 522 for forming the angular velocity mass body 220, the post 230, and the common post 440 are formed. Herein, the first opening portion 521 and the second opening portion 522 may be formed to expose the third insulating layer 150 by the etching process.

In this case, the through hole 511 is formed to penetrate from the opening portion 510 to the first insulating layer 120 to act to smoothly perform air damping of the inertial sensor.

Next, when the second passivation layer 500 is removed, as illustrated in FIG. 2K, the angular velocity mass body 220, the post 230, and the common post 440 are provided and the first electrode 321 and the second electrode 322 are exposed.

In this case, an opening pattern 402 is formed at a part of the cap 400 of the corresponding region so as to expose an edge region of the electrode 210 forming the upper structure of the structural part 200 for an accelerator sensor.

Next, the structure of the inertial sensor including the cap 400 having the opening pattern 402 may be mounted in the apparatus such as the ASIC chip 700 by a flip bonding.

That is, the structure of the inertial sensor illustrated in FIG. 2K is reversed up and down and may be flip-bonded to the apparatus such as the ASIC chip 700 by including the conductive adhesive 701 such as an anisotropic conductive film (ACF) or an anisotropic conductive adhesive (ACA) in the first electrode 321 and the second electrode 322.

Further, a wire 600 is connected with the opening pattern 402 of the cap 400 and the ASIC chip 700 by a wiring bonding, as illustrated in FIG. 2L.

Therefore, the structural part 200 for an accelerator sensor is electrically connected with the ASIC chip 700 by the wire 600 and the structural part 300 for an angular velocity sensor has the first electrode 321 and the second electrode 322 electrically connected with the ASIC chip 700 via the conductive adhesive 701.

Therefore, the method of manufacturing an inertial sensor according to the preferred embodiment of the present invention forms the piezoresistor 201 and the piezoelectric material 310, respectively, on different surfaces while forming the structural part 200 for an accelerator sensor and the structural part 300 for an angular velocity sensor in one structure.

Therefore, the process of forming the structural part 200 for an accelerator sensor and the process of forming the structural part 300 for an angular velocity sensor do not have an effect on each other, in particular, prevent a bad effect of the piezoresistor 310 due to high temperature during the process of forming the piezoresistor 201, thereby improving the process compatibility and improving the reliability of the inertial sensor.

According to the preferred embodiments of the present invention, the small and multi-functional inertial sensor can be implemented by forming the structural part for the accelerator sensor and the structural part for the angular velocity sensor in one structure.

Further, according to the preferred embodiments of the present invention, the method of manufacturing an inertial sensor can prevent a bad effect of the piezoelectric material due to high temperature during the process of forming the piezoresistor without the process of forming the structural part for the accelerator sensor and the process of forming the structural part for the angular velocity sensor having an effect on each other, thereby improving the process compatibility and the reliability of the inertial sensor.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An inertial sensor, comprising:
a structural part for an accelerator sensor disposed on one surface, centered on a common post; and
a structural part for an angular velocity sensor disposed on the other surface, centered on the common post,
wherein a piezoresistor of the structural part for the accelerator sensor and a piezoelectric material of the structural part for the angular velocity sensor are formed on different surfaces.

2. The inertial sensor as set forth in claim 1, wherein the piezoresistor of the structural part for the accelerator sensor and the piezoelectric material of the structural part for the angular velocity sensor are formed in an origin symmetric form, centered on the common post.

3. The inertial sensor as set forth in claim 1, further comprising:
a cap covering one surface; and
an ASIC chip electrically connected with the other surface, corresponding to the cap.

4. The inertial sensor as set forth in claim 1, wherein the structural part for the angular velocity sensor includes:
a first electrode and a second electrode connected with the piezoelectric material, and
the first electrode and the second electrode are electrically connected with the ASIC chip by flip bonding.

5. The inertial sensor as set forth in claim 1, wherein the structural part for the angular velocity sensor includes:
an electrode connected with the piezoresistor; and
a wire penetrating through one portion of the cap to electrically connect between the electrode and the ASIC chip.

6. The inertial sensor as set forth in claim 1, wherein the structural part for the angular velocity sensor further includes:
the piezoresistor disposed at an outer side of a second membrane extendedly disposed on one surface of the common post;
an accelerator mass body disposed under the second membrane, corresponding to the piezoresistor; and
a post surrounding the accelerator mass body.

7. The inertial sensor as set forth in claim 1, wherein the structural part for the angular velocity sensor further includes:
the piezoresistor disposed at an outer side of a first membrane extendedly disposed on the other surface of the common post;
an accelerator mass body disposed under the first membrane, corresponding to the piezoresistor; and
a post surrounding the accelerator mass body.

8. A method of manufacturing an inertial sensor, comprising:
(A) preparing a first substrate including a first membrane and a second substrate including a second membrane;
(B) bonding the first substrate and the second substrate to each other so as to expose the first membrane and the second membrane;
(C) forming an upper structure of a structural part for an accelerator sensor including a piezoresistor disposed on one surface of an outer side of the second membrane and an electrode connected with the piezoresistor;
(D) forming an upper structure of a structural part for an angular velocity sensor including a piezoresistor disposed on one surface of an outer side of the first membrane and an electrode connected with the piezoresistor;
(E) forming an angular velocity mass body contacting the first membrane and a post surrounding the angular velocity mass body, corresponding to the piezoelectric material; and
(F) forming an accelerator mass body contacting the second membrane, a post surrounding the accelerator mass body, and a common post disposed at a center between the angular velocity mass body and the accelerator mass body, corresponding to the piezoresistor.

9. The method as set forth in claim 8, further comprising:
(H) forming a cap on one surface of the inertial sensor; and
(I) disposing an ASIC chip on the other surface of the inertial sensor, corresponding to the cap.

10. The method as set forth in claim 8, wherein the piezoresistor of the structural part for the accelerator sensor and the piezoelectric material of the structural part for the angular velocity sensor are formed in an origin symmetric form, centered on the common post

11. The method as set forth in claim 8, wherein the first substrate and the second substrate are a silicon substrate or a silicon on insulator (SOI) substrate.

12. The method as set forth in claim 8, wherein the step (E) includes:
(E-1) forming a first passivation layer covering an upper structure of the structural part for the accelerator sensor;
(E-2) forming the angular velocity mass body and a post surrounding the angular velocity mass body by an etching process using the first passivation layer; and
(E-3) removing the first passivation layer.

13. The method as set forth in claim 8, wherein the step (F) includes:
(F-1) forming a second passivation layer covering an upper structure of the structural part for the angular velocity sensor;
(F-2) forming the accelerator mass body, a post surrounding the accelerator mass body, and a common post disposed at a center between the angular velocity mass body and the accelerator mass body by the etching process using the second passivation layer; and
(F-3) removing the second passivation layer.

14. The method as set forth in claim 9, wherein a wire penetrates through one portion of the cap to electrically connect between the electrode connected with the piezoresistor and the ASIC chip.

15. The method as set forth in claim 9, wherein the electrode connected with the piezoelectric material is electrically connected with the ASIC chip by flip bonding.
